(19) United States
(12) Patent Application Publication
(10) Pub. No.: US 2024/0286645 A1
(43) Pub. Date: Aug. 29, 2024

(54) VEHICLE

(71) Applicant: TOYOTA JIDOSHA KABUSHIKI KAISHA, Toyota-shi (JP)

(72) Inventors: Sho HASHIMOTO, Susono-shi (JP); Satoshi NAKAMURA, Shizuoka-ken (JP); Tomoki SOMIYA, Okazaki-shi (JP); Kazumasa HARADA, Nagakute-shi (JP); Hiroki YABUSHITA, Toyota-shi (JP); Sei MIYAZAKI, Susono-shi (JP); Yuki NISHIKAWA, Numazu-shi (JP); Noriaki HASEGAWA, Izunokuni-shi (JP)

(73) Assignee: TOYOTA JIDOSHA KABUSHIKI KAISHA, Toyota-shi (JP)

(21) Appl. No.: 18/442,582

(22) Filed: Feb. 15, 2024

(30) Foreign Application Priority Data
Feb. 28, 2023 (JP) 2023-029950

(51) Int. Cl. B60W 60/00

(52) U.S. Cl. CPC B60W 60/0015; B60W 2540/049; B60W 2552/05; B60W 2554/4042; B60W 2554/4048; B60W 2554/406

(57) ABSTRACT

The vehicle includes an interface unit and an active safety device. The active safety device includes an acquisition unit that acquires at least one of surrounding environment information related to the surrounding environment of the vehicle and in-vehicle environment information related to the environment inside the vehicle. The active safety device includes a performance evaluation unit that evaluates the driving performance of the autonomous driving kit based on at least one of surrounding environment information and in-vehicle environment information.

### CROSS-REFERENCE TO RELATED APPLICATION

This application claims priority to Japanese Patent Application No. 2023-029950 filed on Feb. 28, 2023 incorporated herein by reference in its entirety.

### BACKGROUND

### 1. Technical Field

The present disclosure relates to the technical field of vehicles.

### 2. Description of Related Art

For example, a vehicle has been proposed that is autonomously driven by control instructions being output to functional units of the vehicle according to instructions from a detachable autonomous driving kit for a vehicle (Japanese Unexamined Patent Application Publication No. 2021-123146 (JP 2021-123146 A)). A vehicle control system has also been proposed that includes a first unit configured to generate a target trajectory based on a vehicle travel plan, and a second unit configured to perform vehicle travel control so that the vehicle follows the target trajectory. The second unit of the vehicle control system intervenes in a travel controlled variable so as to prevent a collision between the vehicle and an obstacle (see Japanese Unexamined Patent Application Publication No. 2021-062780 (JP 2021-062780 A)).

### SUMMARY

Vehicles that are autonomously driven by an autonomous driving kit are have a technical problem in that autonomous driving cannot be continued if an abnormality occurs in the functions of the autonomous driving kit.

The present disclosure was made in view of the above problem, and it is an object of the present disclosure to provide a vehicle that can detect a sign of abnormality in an autonomous driving kit.

A vehicle according to an aspect of the present disclosure includes an interface unit and an active safety device. The interface unit is configured to communicate with a detachable autonomous driving kit for the vehicle and to give a control instruction related to autonomous driving control to each part of the vehicle based on an instruction from the autonomous driving kit. The active safety device is configured to implement an active safety function of the vehicle. The active safety device includes an acquisition unit configured to acquire either or both of surrounding environment information related to a surrounding environment of the vehicle and in-vehicle environment information related to an environment inside the vehicle. The active safety device includes a performance evaluation unit configured to evaluate driving performance of the autonomous driving kit based on either or both of the surrounding environment information and the in-vehicle environment information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a vehicle according to an embodiment;

FIG. 2 is a flowchart showing an example of the operation of the active safety device according to the embodiment;

FIG. 3 is an example of information showing the relationship between environment information and environmental level;

FIG. 4 is an example of information showing the relationship between the comprehensive environmental level and the threshold;

FIG. 5 is a flowchart showing another example of the operation of the active safety device according to the embodiment; and

FIG. 6 is a flowchart showing another example of the operation of the active safety device according to the embodiment.

### DETAILED DESCRIPTION OF EMBODIMENTS

### Mode for Carrying Out the Disclosure

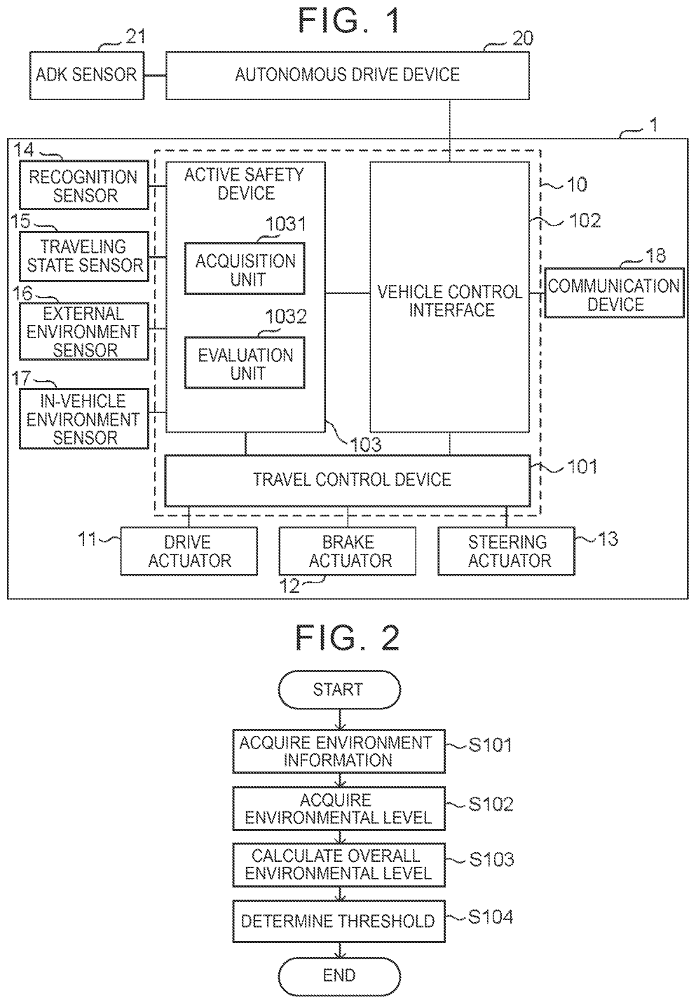

An embodiment related to a vehicle will be described with reference to FIGS. 1 to 6.

### Vehicle Configuration

In FIG. 1, a vehicle 1 includes a driving control system 10, a drive actuator 11, a brake actuator 12, a steering actuator 13, a recognition sensor 14, a driving state sensor 15, an external environment sensor 16, an in-vehicle environment sensor 17, and a communication device 18.

An autonomous driving device 20 is connected to the vehicle 1. The autonomous driving device 20 is a device that is detachable from the vehicle 1 and is independent from the vehicle 1. The autonomous driving device 20 may be wired to the driving control system 10 through a detachable connector. Here, the driving control system 10 is a system specific to the vehicle 1. The driving control system 10 is provided together with the vehicle 1 by an automobile manufacturer. In contrast, the autonomous driving device 20 is often designed and developed by a separate entity from the driving control system 10. Note that the autonomous driving device 20 may be referred to as an Autonomous Driving Kit (ADK).

The driving control system 10 and the autonomous driving device 20 may configure an autonomous driving system for autonomously driving the vehicle 1. Note that “autonomous driving” may mean, for example, autonomous driving at level 3 or higher in the level definition of the Society of Automotive Engineers (SAE).

The driving control system 10 may include one or more processors and memory coupled to the processors. The driving control system 10 may electrically connect in-vehicle actuators (e.g., drive actuator 11, brake actuator 12, and steering actuator 13), on-vehicle sensors (e.g., recognition sensor 14, driving state sensor 15, an external environment sensor 16, an in-vehicle environment sensor 17), and a communication device 18 through an in-vehicle network (e.g., Controller Area Network (CAN)).

The drive actuator 11 is an actuator for accelerating the vehicle 1. The brake actuator 12 is an actuator for decelerating or stopping the vehicle 1. The steering actuator 13 is an actuator for steering the vehicle 1.

The recognition sensor 14 may include at least one of a camera (i.e., an image sensor) and a radar sensor (e.g., millimeter wave radar, laser radar). The recognition sensor 14 is used to detect objects (for example, vehicles, pedestrians, bicycles, and fallen objects) existing around the vehicle 1 and to measure the relative position and velocity of the detected object with respect to the vehicle 1. The driving state sensor 15 may include at least one of a speed sensor, an acceleration sensor, and a yaw rate sensor. The driving state sensor 15 is used to measure at least one of a physical quantity (e.g., speed, acceleration, yaw rate) and a parameter indicating the traveling state of the vehicle 1. The external environment sensor 16 is a sensor that acquires information regarding the external environment of the vehicle 1. External environment sensor 16 may include at least one of a raindrop sensor and a temperature sensor. The in-vehicle environment sensor 17 is a sensor that acquires information regarding the in-vehicle environment of the vehicle 1. The in-vehicle environment sensor 17 may include at least one of a camera, a temperature sensor, and a pressure sensor.

The communication device 18 is a device for the vehicle 1 to perform data communication with the outside. The communication device 18 may be connected to an external communication network by wireless communication. Therefore, the vehicle 1 may be a so-called connected car.

The driving control system 10 includes a driving control device 101, a vehicle control interface 102, and an active safety device 103 as logically realized functional blocks or physically realized processing circuits. Note that the driving control device 101, vehicle control interface 102, and active safety device 103 will be described later.

The autonomous driving device 20 is electrically coupled to the ADK sensor 21. The ADK sensor 21 may be configured integrally with the autonomous driving device 20. The ADK sensor 21 may be detachably attached to the autonomous driving device 20 or the vehicle 1. The ADK sensor 21 is a sensor for acquiring information necessary for the autonomous driving device 20 to drive the vehicle 1. For example, ADK sensor 21 may include a camera, a radar sensor, and a Global Positioning System (GPS) sensor.

The autonomous driving device 20 may have a function of formulating a travel plan. The autonomous driving device 20 may calculate a target trajectory on which the vehicle 1 will travel based on the created travel plan and the information acquired by the ADK sensor 21. For example, the target trajectory may include a sequence of points indicating a plurality of target positions of the vehicle 1, and at least one of a target speed and a target acceleration at each of the plurality of target positions. The autonomous driving device 20 transmits the calculated target trajectory to the driving control system 10. Note that the autonomous driving device 20 may repeatedly calculate the target trajectory and transmit the calculated target trajectory to the driving control system 10 at a predetermined period.

The target trajectory transmitted from the autonomous driving device 20 is input to the driving control device 101 via the vehicle control interface 102 of the driving control system 10. For example, the driving control device 101 determines the drive control amount to be instructed to the drive actuator 11, the brake control amount to be instructed to the brake actuator 12, and the steering actuator 13 based on the target trajectory and the measurement results of the driving state sensor 15. At least one of the steering control 10 amounts to be instructed is calculated.

The active safety device 103 is a device that intervenes in the driving control device 101 to prevent or avoid a collision between the vehicle 1 and an object. As control to prevent or avoid a collision between the vehicle 1 and an object includes control to prevent the vehicle 1 from departing from the lane (e.g., lane departure prevention control, lane keeping support control), control to keep the distance constant between the vehicle 1 and the preceding vehicle (e.g., inter-vehicle distance control), and control to automatically apply braking force to the vehicle 1 when there is a high possibility of a collision between the vehicle 1 and an object (e.g., collision damage reduction brakes).

An example of a method for the active safety device 103 to intervene in the driving control device 101 is a method in which the active safety device 103 gives an intervention control amount to the driving control device 101. In this case, the intervention control amount may include at least one of a drive control amount, a braking control amount, and a steering control amount. When the active safety device 103 gives the driving control device 101 an intervention control amount, the driving control device 101 calculates the control amount calculated from the target trajectory (specifically, the drive control amount, braking control amount, and steering control amount). Priority is given to the intervention control amount over at least one of the following. The driving control device 101 controls at least one of the drive actuator 11, the brake actuator 12, and the steering actuator 13 according to the intervention control amount.

By the way, the autonomous driving device 20 detects objects existing around the vehicle 1 based on information acquired by the ADK sensor 21. Then, the autonomous driving device 20 calculates a target trajectory so that the vehicle 1 does not collide with the detected object. Therefore, theoretically, the driving control device 101 controls the control amount (specifically, at least one of the drive control amount, the braking control amount, and the steering control amount) according to the target trajectory calculated by the autonomous driving device 20. If calculated, a collision between the vehicle 1 and the object will not occur. However, due to some abnormality occurring in the autonomous driving device 20, the driving performance of the autonomous driving device 20 may permanently or temporarily deteriorate. Therefore, the active safety device 103 may operate as a last resort to prevent or avoid a collision between the vehicle 1 and an object.

From the viewpoint of active safety, the active safety device 103 has a function as a performance evaluation device that evaluates the driving performance of the autonomous driving device 20. The active safety device 103 may evaluate the driving performance of the autonomous driving device 20 based on information obtained from at least one of the recognition sensor 14, the driving state sensor 15, the external environment sensor 16, and the in-vehicle environment sensor 17. Details of the evaluation of the driving performance of the autonomous driving device 20 will be described later. The active safety device 103 may take measures according to the evaluation results of the driving performance of the autonomous driving device 20.

### Performance Evaluation Method

A method of evaluating the driving performance of the autonomous driving device 20 performed by the active safety device 103 will be described. In the flowchart of FIG. 2, the acquisition unit 1031 of the active safety device 103 acquires environment information (S101). The environment information is information indicating the environment in which the vehicle 1 is placed. The environment information may include information indicating the environment outside the vehicle 1 and information indicating the environment inside the vehicle 1. The active safety device 103 may acquire environment information based on information obtained from at least one of the recognition sensor 14, the driving state sensor 15, the external environment sensor 16, and the in-vehicle environment sensor 17. Note that the environment information may include information regarding at least one of a physical quantity and a parameter that may affect the operation of the vehicle 1.

For example, the environment information may include at least one of the following pieces of information: information on the speed of any surrounding vehicle traveling around the vehicle 1, information on the type of road the vehicle 1 is traveling on (e.g., road exclusively for motor vehicles, local road), and information on the visibility due to weather, information on the time of day, information on the amount of traffic, information on the level of blind spot, information on the number of occupants standing in the vehicle 1, and information on the number of elderly occupants in the vehicle 1. Note that the environment information is not limited to the information listed here.

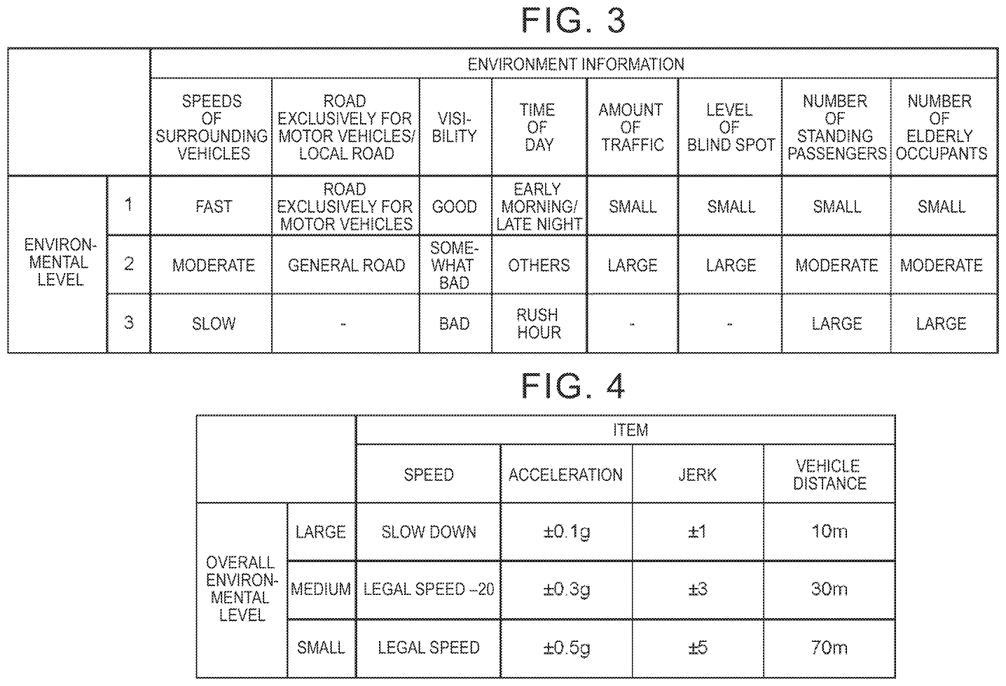

Next, the evaluation unit 1032 of the active safety device 103 acquires the environmental level based on the information that defines the relationship between the environment information and the environmental level as shown in, for example, FIG. 3, and the environment information acquired in step S101 (S102).

For example, when the information regarding the speed of the surrounding vehicle included in the environment information indicates “moderate”, the evaluation unit 1032 sets the environmental level regarding the speed of the surrounding vehicle to “2”. Note that “fast” may mean a speed of 80 kilometers per hour or more. A “moderate” speed may mean a speed between 30 kilometers per hour and 80 kilometers per hour. A “slow” speed may mean a speed of 30 kilometers per hour or less.

For example, when the information regarding the type of road included in the environment information indicates “general road”, the evaluation unit 1032 sets the environmental level related to the type of road to “2”. For example, when the information regarding the degree of visibility caused by the weather included in the environment information indicates “good”, the evaluation unit 1032 sets the environmental level related to the degree of visibility to “1”. Note that “good” visibility may mean that it is not raining and that it is bright. The visibility level “slightly poor” may mean that it is raining lightly during the day, or that it is not raining at night. “Poor” visibility may mean that it is raining heavily or snowing regardless of the time of day, that it is raining or snowing at night, or that there is a dense fog.

For example, when the information regarding the time of day included in the environment information indicates “rush hour,” the evaluation unit 1032 sets the environmental level related to the time zone to “3.” Note that “rush hour” is a concept that includes morning rush hour (for example, from 7 o'clock to 9 o'clock) and night rush hour (for example, from 18 o'clock to 20 o'clock). For example, when the information regarding the amount of traffic included in the environment information indicates “large”, the evaluation unit 1032 sets the environmental level regarding the amount of traffic to “2”.

For example, when the information regarding the level of blind spot included in the environment information indicates “less”, the evaluation unit 1032 sets the environmental level related to the level of blind spot to “1”. Here, the blind spot refers to an area in front of the vehicle 1 that cannot be seen from the vehicle 1 due to obstacles including other vehicles and structures. The level of blind spot may be expressed as the number of obstacles that create the blind spot. Alternatively, the level of blind spot may be expressed as the area of the blind spot.

For example, when the information regarding the number of occupants standing in the vehicle 1 included in the environment information indicates “few”, the evaluation unit 1032 sets the environmental level related to the number of occupants standing in the vehicle 1 to be “1”. Note that information regarding the number of occupants standing in the vehicle 1 may be acquired only when the type of vehicle 1 is a bus. Note that the number of standing occupants being “small” may mean that the number of standing occupants is two or less. A “moderate” number of standing passengers may mean that the number of standing passengers is three to six. The number of standing occupants being “large” may mean that the number of standing occupants is seven or more.

For example, when the information on the number of elderly occupants in the vehicle 1 included in the environment information indicates “small,” the evaluation unit 1032 sets the environmental level related to the number of elderly occupants to “1.” A “small” number of elderly occupants may mean that the number of elderly occupants is two or less. A “moderate” number of elderly occupants may mean that the number of elderly occupants is three to six. A “large” number of elderly occupants may mean that the number of elderly occupants is seven or more.

Next, the evaluation unit 1032 calculates a comprehensive environmental level based on the environmental level acquired in the process of S102 (S103). The method for calculating the overall environmental level will be described regarding an example in which the environmental level related to the speed of any surrounding vehicle is “2,” the environmental level related to the type of road is “2,” the environmental level related to the visibility is “1,” and the environmental level related to the time of day is “3,” the environmental level related to the amount of traffic is “2,” the environmental level related to the level of blind spot is “1,” the environmental level related to the number of occupants standing in the vehicle is “1,” the environmental level related to the number of elderly occupants is “1” in step S102.

The evaluation unit 1032 may calculate the overall environmental level by performing weighted addition for the plurality of environmental levels. For example, the weight related to the speed of surrounding vehicles is “5,” the weight related to the type of road is “3,” the weight related to visibility is “5,” and the weight related to time of day is “1,” the weight related to the amount of traffic is “1,” the weight related to the level of blind spot is “4,” the weight related to the number of standing occupants is “2,” and the weight related to the number of elderly occupants is “1.” Note that the weight may be set depending on the degree of influence on the driving of the vehicle 1. In this case, the overall environmental level is “33(=5×2+3×2+5×1+1×3+1×2+4×1+2×1+1×1)”.

Next, the evaluation unit 1032 determines a threshold based on information indicating the relationship between the comprehensive environmental level and the threshold, as shown in FIG. 4, for example, and the comprehensive environmental level calculated in the process of S103 (S104). In addition, in FIG. 4, the overall environmental level “high” may mean that the overall environmental level is 40 or higher. When the overall environmental level is “medium”, it may mean that the overall environmental level is greater than 10 and less than 40. The expression that the overall environmental level is “small” may mean that the overall environmental level is 10 or less.

When the overall environmental level calculated in the process of S103 is “33”, the evaluation unit 1032 sets the speed threshold to “legal speed-20 kilometers per hour”, the acceleration threshold to “±0.3 g”, and jerk. The threshold related to the following distance may be determined to be “±3”, and the threshold related to the inter-vehicle distance may be determined to be “30 m”. Note that the thresholds shown in FIG. 4 are merely examples, and the present disclosure is not limited thereto.

Note that the active safety device 103 may repeatedly perform the operation shown in the flowchart of FIG. 2 at a predetermined period (for example, every 5 minutes or every time the vehicle 1 travels 1 kilometer).

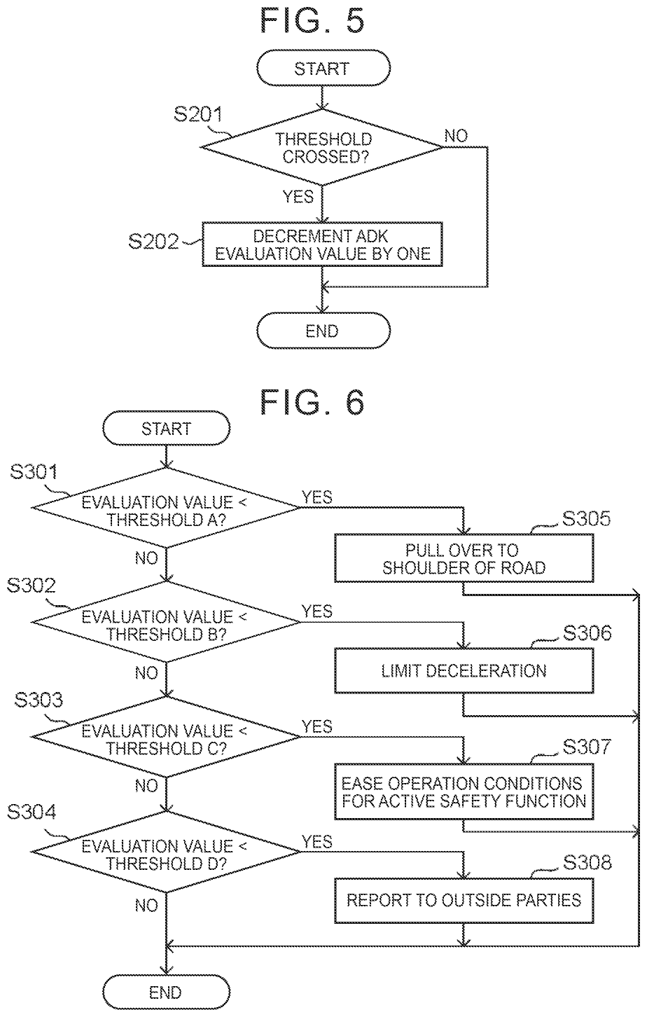

In the flowchart of FIG. 5, the evaluation unit 1032 of the active safety device 103 determines, based on the information obtained from the recognition sensor 14 and the driving state sensor 15, that at least one of the following has crossed a threshold (i.e., the threshold determined in S104 of the flowchart of FIG. 2): speed of the vehicle 1, acceleration, jerk, and inter-vehicle distance (S201). Here, “crossing the threshold” may mean “exceeding the threshold” for each of the speed, acceleration, and jerk of the vehicle 1, and may mean “below the threshold” for the inter-vehicle distance.

In the determination of S201, when it is determined that the threshold has been crossed (S201: Yes), the evaluation unit 1032 reduces the evaluation value related to the autonomous driving device 20 by 1 (S202). Thereafter, the process of S201 may be executed after a first predetermined time (for example, several tens of milliseconds to several hundred milliseconds) has elapsed. That is, the operation shown in the flowchart of FIG. 5 may be repeatedly performed at a period corresponding to the first predetermined time. Note that the “evaluation value related to the autonomous driving device 20” corresponds to an example of the “evaluation result of the driving performance of the autonomous driving device 20.”

In addition, in the process of S201, if it is determined that the threshold has been crossed because at least one of the speed, acceleration, and jerk of the vehicle 1 significantly exceeds the threshold, or the inter-vehicle distance significantly falls below the threshold. (S201: No), the evaluation unit 1032 may greatly reduce the evaluation value related to the autonomous driving device 20 (for example, by 5).

In the determination of S201, if it is determined that the threshold is not crossed (S201: No), the operation shown in the flowchart of FIG. 5 is ended. Thereafter, the process of S201 may be executed after the first predetermined time period has elapsed. In addition, in the determination of S201, if it is determined that the threshold is not crossed (S201: No), the evaluation unit 1032 evaluates the evaluation value of the autonomous driving device 20 on the condition that the evaluation value is smaller than the initial value. You can increase it by 0.1.

Alternatively, if the evaluation value related to the autonomous driving device 20 is smaller than the initial value, the evaluation unit 1032 performs the evaluation in S201 within a second predetermined time (for example, 5 seconds) after it is determined that the threshold has been crossed in the determination in S201. The evaluation value related to the autonomous driving device 20 may be increased by 0.1 on the condition that it is not determined that the threshold has been crossed in the determination. The evaluation unit 1032 may set the evaluation value related to the autonomous driving device 20 to an initial value (that is, may reset it) when the vehicle 1 is in the ignition OFF state. In addition, when the position that the vehicle 1 is traveling changes from one preset area to another area (for example, when it moves from a road exclusively for motor vehicles to a local road, from an urban area to a suburban area), the evaluation unit 1032 may set the evaluation value related to the autonomous driving device 20 to the initial value (that is, may be reset).

The active safety device 103 performs the operation shown in the flowchart of FIG. 6 in parallel with the operation shown in the flowchart of FIG. 5. In FIG. 6, threshold A is smaller than threshold B, threshold B is smaller than threshold C, and threshold C is smaller than threshold D (that is, threshold A<threshold B<threshold C<threshold D).

In FIG. 6, the active safety device 103 determines whether the evaluation value related to the autonomous driving device 20 is smaller than the threshold A (S301). In the process of S301, if it is determined that the evaluation value related to the autonomous driving device 20 is smaller than the threshold A (S301: Yes), the active safety device 103 instructs the driving control device 101 to cause the vehicle 1 to retreat to the shoulder of the road. Intervention is performed (S305).

In the process of S301, if it is determined that the evaluation value related to the autonomous driving device 20 is equal to or higher than the threshold A (S301: No), the active safety device 103 determines whether the evaluation value related to the autonomous driving device 20 is smaller than the threshold B (S302). In the process of S302, if it is determined that the evaluation value related to the autonomous driving device 20 is smaller than the threshold B (S302: Yes), intervention is performed on the driving control device 101 by the active safety device 103 so that the speed of the vehicle 1 is limited (for example, the speed of the vehicle 1 does not exceed a predetermined speed) (S306).

In the process of S302, if it is determined that the evaluation value related to the autonomous driving device 20 is equal to or higher than the threshold B (S302: No), the active safety device 103 determines whether the evaluation value related to the autonomous driving device 20 is smaller than the threshold C (S303). In the process of S303, if it is determined that the evaluation value related to the autonomous driving device 20 is smaller than the threshold C (S303: Yes), the active safety device 103 relaxes the operating conditions of the active safety function (in other words, the active safety function The operating conditions are changed to make the function easier to operate) (S307).

In the process of S303, if it is determined that the evaluation value related to the autonomous driving device 20 is equal to or higher than the threshold C (S303: Yes), the active safety device 103 determines whether the evaluation value related to the autonomous driving device 20 is smaller than the threshold D (S304). In the process of S304, if it is determined that the evaluation value related to the autonomous driving device 20 is smaller than the threshold D (S304: Yes), the active safety device 103 controls the vehicle 1 via the vehicle control interface 102 and the communication device 18. A notification is made to the outside (S308).

In the process of S308, the active safety device 103 may report to HELPNET. Note that HELPNET refers to a management center for emergency response operated by at least one of a business that provides the vehicle 1 and a business that maintains the vehicle 1. As a result of the process in S308, the HELPNET operator may perform emergency response regarding the vehicle 1. Alternatively, as a result of the process in S308, emergency response regarding the vehicle 1 may be performed by an autonomous response of the HELPNET system. For example, as an emergency response for the vehicle 1, a vehicle stop instruction may be transmitted from HELPNET to the vehicle 1.

In the process of S304, when it is determined that the evaluation value related to the autonomous driving device 20 is equal to or greater than the threshold D (S304: No), the operation shown in the flowchart of FIG. 6 is ended. After that, the process of S301 may be performed.

### Technical Effect

When the vehicle 1 is traveling according to the target trajectory calculated by the autonomous driving device 20, the speed etc. of the vehicle 1 straddles the threshold (that is, the threshold determined by the process of S104 in the flowchart of FIG. 2). It can be interpreted that the driving manner of the vehicle 1 is not appropriate for the environment in which the vehicle 1 is placed. In this case, it can be said that the autonomous driving device 20 is unable to calculate a target trajectory suitable for the environment in which the vehicle 1 is placed.

The active safety device 103 reduces the evaluation value related to the autonomous driving device 20 when the speed etc. of the vehicle 1 cross a threshold. Therefore, the fact that the evaluation value begins to decrease can be interpreted as a sign that an abnormality is occurring in the autonomous driving device 20. Therefore, it can be said that the vehicle 1 equipped with the active safety device 103 can detect signs of abnormality in the autonomous driving device 20.

In addition, if the evaluation value related to the autonomous driving device 20 decreases by more than a predetermined value (for example, if the evaluation value falls below at least one of the thresholds A, B, C, and D in the flowchart of FIG. 6), the active safety device 103 intervenes in the driving control device 101. Here, if the evaluation value related to the autonomous driving device 20 has decreased by a predetermined value or more, there is a high possibility that an abnormality has occurred in the autonomous driving device 20. In this case, the safety of the vehicle 1 can be ensured by the active safety device 103 intervening with the driving control device 101.

Aspects of the disclosure derived from the embodiments described above will be described below.

A vehicle according to one aspect of the disclosure includes: an interface unit; and an active safety device, the interface unit being configured to communicate with a detachable autonomous driving kit for the vehicle and to give a control instruction related to autonomous driving control to each part of the vehicle based on an instruction from the autonomous driving kit, and the active safety device being configured to implement an active safety function of the vehicle, wherein the active safety device includes an acquisition unit configured to acquire either or both of surrounding environment information related to a surrounding environment of the vehicle and in-vehicle environment information related to an environment inside the vehicle, and the active safety device includes a performance evaluation unit configured to evaluate driving performance of the autonomous driving kit based on either or both of the surrounding environment information and the in-vehicle environment information.

In the embodiment described above, the “autonomous driving device 20” corresponds to an example of an “autonomous driving kit,” the “vehicle control interface 102” corresponds to an example of an “interface unit,” and the “acquisition unit 1031” corresponds to an example of an “acquisition unit.” The evaluation unit 1032 corresponds to an example of the “performance evaluation unit.”

In the vehicle, the performance evaluation unit may be configured to acquire an environmental level based on either or both of the surrounding environment information and the in-vehicle environment information, the environmental level indicating a degree of influence either or both of the surrounding environment and the environment inside the vehicle has on traveling of the vehicle, and the performance evaluation unit may be configured to evaluate the driving performance of the autonomous driving kit according to the acquired environmental level.

The surrounding environment information may include at least one of following pieces of information: information indicating a speed of any other vehicle traveling around the vehicle, information indicating whether a road on which the vehicle is traveling is a road exclusively for motor vehicles, information related to visibility of the road on which the vehicle is traveling, information indicating a time of day during which the vehicle is traveling, information indicating an amount of traffic on the road on which the vehicle is traveling, and information indicating a level of blind spot on the road on which the vehicle is traveling. The in-vehicle environment information may include either or both of the number of occupants standing in the vehicle and the number of elderly occupants in the vehicle.

The present disclosure is not limited to the embodiments described above, and can be modified as appropriate within the scope or spirit of the disclosure that can be read from the claims and the entire specification, and vehicles with such modifications may also be modified. This is within the technical scope of the present disclosure.

What is claimed is:

1. A vehicle comprising: an interface unit; and an active safety device, the interface unit being configured to communicate with a detachable autonomous driving kit for the vehicle and to give a control instruction related to autonomous driving control to each part of the vehicle based on an instruction from the autonomous driving kit, and the active safety device being configured to implement an active safety function of the vehicle, wherein
the active safety device includes an acquisition unit configured to acquire either or both of surrounding environment information related to a surrounding environment of the vehicle and in-vehicle environment information related to an environment inside the vehicle, and
the active safety device includes a performance evaluation unit configured to evaluate driving performance of the autonomous driving kit based on either or both of the surrounding environment information and the in-vehicle environment information.

2. The vehicle according to claim 1, wherein:
the performance evaluation unit is configured to acquire an environmental level based on either or both of the surrounding environment information and the in-vehicle environment information, the environmental level indicating a degree of influence either or both of the surrounding environment and the environment inside the vehicle has on traveling of the vehicle; and
the performance evaluation unit is configured to evaluate the driving performance of the autonomous driving kit according to the acquired environmental level.

3. The vehicle according to claim 1, wherein the surrounding environment information includes at least one of following pieces of information: information indicating a speed of any other vehicle traveling around the vehicle, information indicating whether a road on which the vehicle is traveling is a road exclusively for motor vehicles, information related to visibility of the road on which the vehicle is traveling, information indicating a time of day during which the vehicle is traveling, information indicating an amount of traffic on the road on which the vehicle is traveling, and information indicating a level of blind spot on the road on which the vehicle is traveling.

4. The vehicle according to claim 1, wherein the in-vehicle environment information includes either or both of the number of occupants standing in the vehicle and the number of elderly occupants in the vehicle.
